(19) United States
(12) Patent Application Publication
(10) Pub. No.: US 2026/0169832 A1
(43) Pub. Date: Jun. 18, 2026

(54) SERVICE API DISCOVERY BASED ON A SERVER DATASET USING THE COMMON API FRAMEWORK

(71) Applicant: InterDigital Patent Holdings, Inc., Wilmington, DE (US)

(72) Inventors: Michel Roy, Candiac (CA); Michael Starsinic, Newtown, PA (US); Kevin Di Lallo, Laval (CA); Achref Methenni, Montreal (CA)

(73) Assignee: InterDigital Patent Holdings, Inc., Wilmington, DE (US)

(21) Appl. No.: 18/986,149

(22) Filed: Dec. 18, 2024

(51) Int. Cl. G06F 9/54

(52) U.S. Cl. CPC G06F 9/546

(57) ABSTRACT

Systems and methods are described herein for service application programming interface (API) discovery based on a server dataset using the common API framework. A common API framework (CAPIF) may enable server and/or API discovery based on a server's dataset and/or private dataset. A CAPIF core function (CCF) may perform server and/or API discovery, for example, in scenarios where the CCF may have limited access or no access to a server's dataset.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems and methods are described herein for service application programming interface (API) discovery based on a server dataset using the common API framework. A common API framework (CAPIF) may enable server and/or API discovery based on a server's dataset and/or private dataset. A CAPIF core function (CCF) may perform server and/or API discovery, for example, in scenarios where the CCF may have limited access or no access to a server's dataset.

A first network entity (e.g., CCF network entity) may enable server and/or API discovery. The first network entity (e.g., CCF network entity) may receive a message from an API provider (e.g., server). The first network entity may receive a first message from a first API provider and receive a second message from a second API provider. The first message may indicate first dataset metadata associated with the first API provider and/or a first dataset filtering endpoint associated with the first API provider. The second message may indicate second dataset metadata associated with the second API provider and/or a second dataset filtering endpoint associated with the second API provider. The first network entity may receive a service API discovery request (e.g., from a wireless transmit/receive unit (WTRU) or separate network entity). The service API discovery request may indicate a dataset parameter (e.g., requirement). The first network entity may determine (e.g., perform a first service API determination) whether there is a service API (e.g., that meets a condition). For example, the first network entity may determine that the first API provider and/or the second API provider fail to satisfy a condition, for example, based on the first dataset metadata, the second dataset metadata, and the dataset parameter (e.g., requirement). The first network entity may send a dataset filtering request (e.g., based on the determination that the first API provider and/or the second API provider fail to satisfy the condition). The first network entity may send a dataset filtering request based on a (e.g., any) condition or failure to satisfy a condition. The dataset filtering request may be sent based on the first dataset filtering endpoint and/or the second dataset filtering endpoint. The dataset filtering request may be sent to the first API provider based on the first dataset metadata and/or the dataset parameter (e.g., requirement). The dataset filtering request may be sent to the second API provider based on the second dataset metadata and/or the dataset parameter (e.g., requirement). The dataset filtering request may indicate the dataset parameter (e.g., requirement). The first network entity may receive a dataset filtering response (e.g., indicating success, failure, or partial success). The dataset filtering response may indicate a capability and/or a dataset. The first network entity may select (e.g., at least one of) the first API provider or the second API provider based on the dataset filtering response. The first network entity may send a service API discovery response based on the selected API provider (e.g., first API provider or second API provider).

In examples, the dataset metadata may indicate one or more of location information, time information, a dataset category, a set of data sources, a set of networks, a set of network slices, and/or a set of network functions.

In examples, the dataset parameter (e.g., requirement) may indicate one or more of a network, a network slice, or a network function.

In examples, the service API discovery request may indicate that the dataset parameter (e.g., requirement) is associated with sensitive information. Based on a determination that the dataset parameter (e.g., requirement) is associated with sensitive information, the dataset parameter (e.g., requirement) may be included in the dataset filtering request, for example, without being evaluated (e.g., by the CCF).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example CCF service API discovery based on a server dataset.

FIG. 3 shows an example CAPIF API discovery based on a distributed dataset.

### DETAILED DESCRIPTION

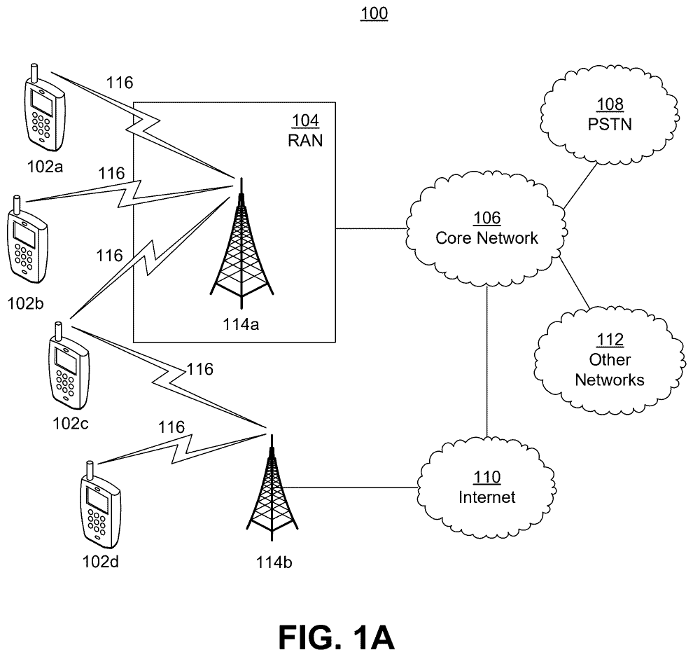

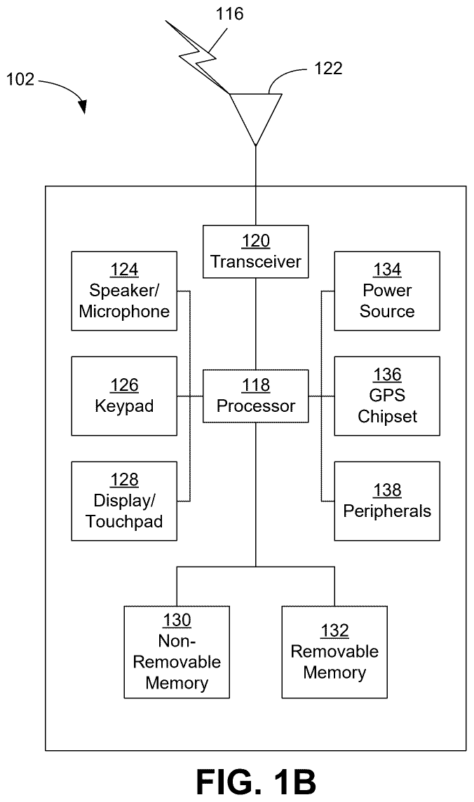

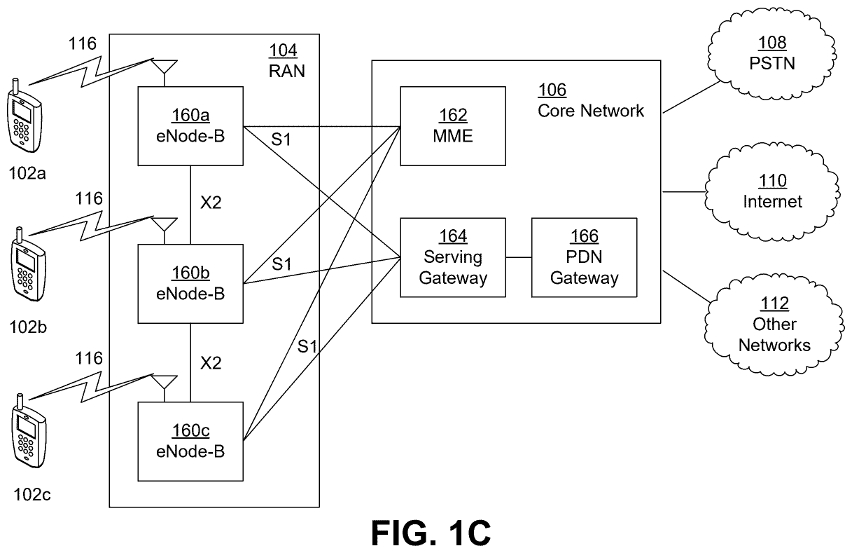

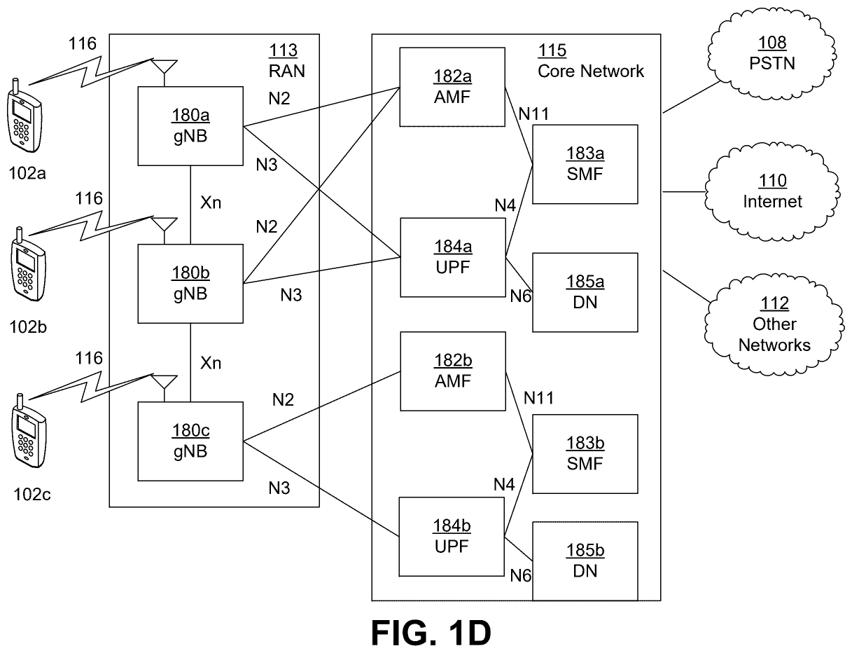

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, one or more emulation devices may perform one or more, or all, functions while being fully or partially implemented and/or deployed as part of a wired and/or wireless communication network to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network to implement testing of one or more components. The one or more emulation devices may be testing equipment. Direct RF coupling and/or wireless communications via RF circuitry (e.g., which may include one or more antennas) may be used by the emulation devices to transmit and/or receive data.

Systems and methods are described herein for service application programming interface (API) discovery based on a server dataset using the common API framework. A common API framework (CAPIF) may enable server and/or API discovery based on a server's dataset and/or private dataset. A CAPIF core function (CCF) may perform server and/or API discovery, for example, in scenarios where the CCF may have limited access or no access to a server's dataset.

A first network entity (e.g., CCF network entity) may enable server and/or API discovery. The first network entity (e.g., CCF network entity) may receive a message from an API provider (e.g., server). The first network entity may receive a first message from a first API provider and receive a second message from a second API provider. The first message may indicate a first dataset metadata associated with the first API provider and/or a first dataset filtering endpoint associated with the first API provider. The second message may indicate a second dataset metadata associated with the second API provider and/or a second dataset filtering endpoint associated with the second API provider. The first network entity may receive a service API discovery request (e.g., from a wireless transmit/receive unit (WTRU) or separate network entity). The service API discovery request may indicate a dataset (e.g., requirement). The first network entity may determine (e.g., perform a first service API determination) whether there is a service API (e.g., that meets a condition). For example, the first network entity may determine that the first API provider and/or the second API provider fail to satisfy a condition, for example, based on the first dataset metadata, the second dataset metadata, and the dataset parameter (e.g., requirement). The first network entity may send a dataset filtering request (e.g., based on the determination that the first API provider and/or the second API provider fail to satisfy the condition). The dataset filtering request may be sent based on the first dataset filtering endpoint and/or the second dataset filtering endpoint. The dataset filtering request may be sent to the first API provider based on the first dataset metadata and/or the dataset parameter (e.g., requirement). The dataset filtering request may be sent to the second API provider based on the second dataset metadata and/or the dataset parameter (e.g., requirement). The dataset filtering request may indicate the dataset parameter (e.g., requirement). The first network entity may receive a dataset filtering response (e.g., indicating success, failure, or partial success). The dataset filtering response may indicate a capability and/or a dataset. The first network entity may select (e.g., at least one of) the first API provider or the second API provider based on the dataset filtering response. The first network entity may send a service API discovery response based on the selected API provider (e.g., first API provider or second API provider).

In examples, the dataset metadata may indicate one or more of location information, time information, a dataset category, a set of data sources, a set of networks, a set of network slices, and/or a set of network functions.

In examples, the dataset parameter (e.g., requirement) may indicate one or more of a network, a network slice, or a network function.

In examples, the service API discovery request may indicate that the dataset parameter (e.g., requirement) is associated with sensitive information. Based on a determination that the dataset parameter (e.g., requirement) is associated with sensitive information, the dataset parameter (e.g., requirement) may be included in the dataset filtering request, for example, without being evaluated (e.g., by the CCF).

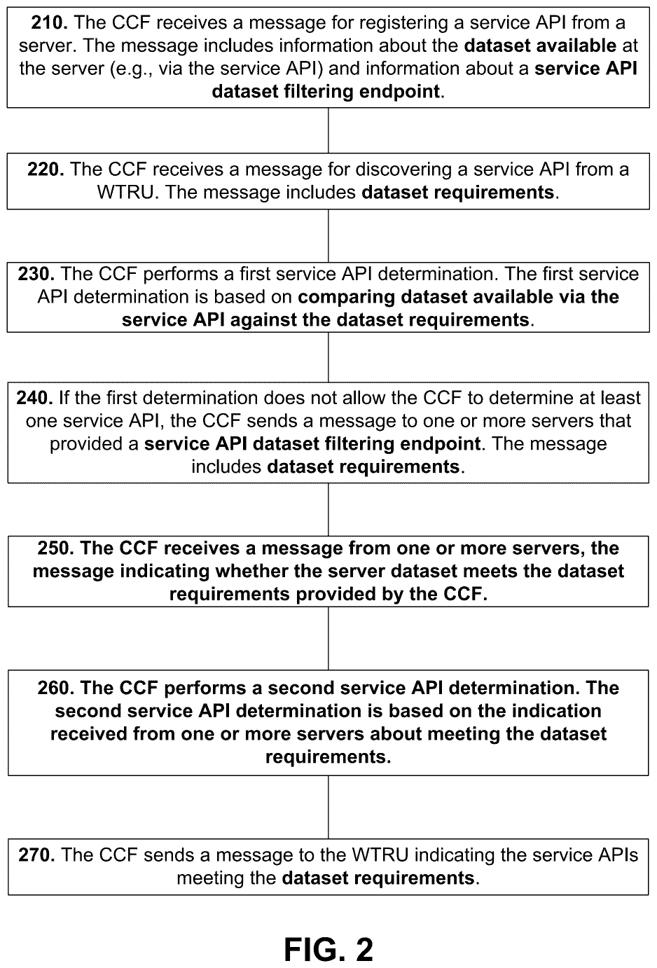

Details associated with a common application programming interface (API) framework (CAPIF) (e.g., performed by a CAPIF core function (CCF), may be described herein. FIG. 2 illustrates example action(s) performed by a CCF. FIG. 2 illustrates an example CCF service API discovery based on a server dataset.

As shown in FIG. 2 at 210, the CCF may receive a message, for example, for publishing a service API from one or more server(s) (e.g., from a first API provider server and/or a second API provider server). The message may include information about the dataset available at the server (e.g., available via the service API) and information about a service API dataset filtering endpoint. The information about the dataset available at the server may include dataset metadata. The message may indicate information associated with the service API associated with the API provider (e.g., server). For example, the CCF may receive a first message from a first API provider indicating first dataset metadata associated with the first API provider and/or a first dataset filtering endpoint. The CCF may receive a second message from a second API provider indicating second dataset metadata associated with the second API provider and/or a second dataset filtering endpoint.

As shown in FIG. 2 at 220, the CCF may receive a message (e.g., service API discovery request), for example, for discovering a service API from a WTRU (e.g., an API invoker on a WTRU). The message may include a dataset parameter (e.g., requirement(s) and/or a service API parameter (e.g., requirement). The service API discovery request may be received from the WTRU or a separate network entity.

As shown in FIG. 2 at 230, the CCF may perform a first service API determination. The first service API determination may be based on comparing the information about the dataset available at the server (e.g., available via the service API) against the dataset parameter (e.g. requirement(s)). The first service API determination may include determining whether a first API provider and/or second API provider satisfy a condition (e.g., API determination condition). The network entity (e.g., CCF) may determine whether an API provider satisfies a condition based on the dataset metadata associated with the API provider and/or the dataset parameter (e.g., requirement(s)). The network entity (e.g., CCF) may determine whether a first API provider and/or a second API provider satisfy a condition based on the first dataset metadata associated with the first API provider, second dataset metadata associated with the second API provider, and/or the dataset parameter (e.g., requirement(s)). For example, the network entity (e.g., CCF) may determine that the first API provider and/or the second API provider fail to satisfy the condition (e.g., based on the first dataset metadata, second dataset metadata, and/or the dataset parameter (e.g., requirement(s)).

As shown in FIG. 2 at 240, the CCF may send a message (e.g., dataset filtering request) to one or more servers that provided a service API dataset filtering endpoint, for example, if the CCF is unable to determine at least one service API during the first determination. The message may include the dataset parameters (e.g., requirements). For example, the CCF may (e.g., based on a determination that the CCF may be unable to determine at least one service API during the first determination, e.g., determine that the first API provider and the second API provider fail to satisfy the condition) send a message (e.g., dataset filtering request) based on at least one of the first dataset filtering endpoint and the second dataset filtering endpoint.

As shown in FIG. 2 at 250, the CCF may receive a message from one or more servers (e.g., API providers). The message may include a dataset filtering response. The message may indicate whether the server dataset meets the dataset parameters (e.g., requirement) provided by the CCF (e.g., a capability). The message may indicate a dataset associated with the API provider. For example, the message may be received from a first API provider (e.g., which may indicate a success or failure). A second message may be received from the second API provider (e.g., which may indicate a success or a failure).

As shown in FIG. 2 at 260, the CCF may perform a second service API determination (e.g., select an API provider). The second service API determination (e.g., API provider selection) may be performed based on the indication received from one or more servers about meeting the dataset parameters (e.g., requirement). For example, the second service API determination may select a first API provider if the message received from the first API provider indicates success. For example, the second service API determination may refrain from selecting a second API provider if the message received from the second API provider indicates failure.

As shown in FIG. 2 at 270, the CCF may send a message to the WTRU indicating the service APIs meeting the dataset parameters (e.g., requirements).

Details associated with a CAPIF may be provided and/or described herein. The Common API Framework may include a standardized framework, for example, to streamline the exposure, discovery, and invocation of APIs in mobile networks. The CAPIF may support systems (e.g., 5G systems) and may be applicable to other generations of mobile networks, offering a uniform mechanism for interaction between third-party applications and network capabilities.

CAPIF functional entities may be described herein.

The API Provider domain functional entities (e.g., the API exposing function, the API publishing function, and the API management function) may offer network services or functions via APIs. An API provider may include a server offering a service, for example, via an API. For example, a server (e.g., as an API provider) may offer a location management service that provides location information. For example, a server (e.g., as an API provider) may offer a spatial map service that provides spatial maps.

The API Invoker functional entity may consume or use discovered APIs to access a service. For example, a WTRU (e.g., as an API invoker) may discover and use a service API to obtain location information or spatial maps.

The CAPIF Core Function (CCF) functional entity may offer services that allow the API providers and/or API invokers to interact. For example, the CCF may offer a service to ensure that published APIs may be exposed (e.g., securely exposed) to API invokers, e.g., to enable the discovery of available APIs and their associated metadata, and to manage security for both API invokers and providers.

CAPIF may be used in the interaction (e.g., to simplify the interaction) between mobile networks and external applications, for example, enhancing the network services ecosystem by promoting interoperability, flexibility, and security.

The CAPIF may enable service API invokers to discover and use APIs published by API providers. CAPIF's API discovery capabilities may determine (e.g., be limited to determining) service APIs, for example, based on comparing the provided API metadata using common relational operators.

In CAPIF service API discovery, CAPIF may not have access to the underlying server's (e.g., the API provider server) dataset. CAPIF may use (e.g., rely on) limited API information to determine a service API requested by an API consumer. Access to a server's dataset may be used (e.g., necessary) to determine if the service API can fulfill the API invoker's parameters (e.g., requirement).

In CAPIF service API discovery, CAPIF may assume that a (e.g., every) server offering an API may have an equivalent dataset, and CAPIF determines the suitability of service APIs without considering the underlying server's (e.g., the API provider server) dataset. API providers may have different datasets. CAPIF may (e.g., need to) consider the dataset of the API provider to determine if a service API can meet the API consumer requirements (e.g., CAPIF may refrain from assuming that API providers share an equivalent dataset).

In CAPIF service API discovery, CAPIF may interpret a server's (e.g., an API provider server) dataset to determine if the API invoker requests or requirements can be met (e.g., assuming that CAPIF may access the server's dataset). For example, a spatial mapping server may have a dataset composed of sensor information (e.g., which may be used to generate spatial maps). It may be beyond CAPIF capabilities to determine if the sensor information (e.g., the dataset) of a spatial map server is sufficient to generate a spatial map for an area of interest provided by an API invoker.

Functions, procedures, and information flows may be provided and/or described herein, for example, which may enable (e.g., be needed to enable) CAPIF to determine the suitability of service APIs considering a server's dataset.

Determining the suitability of a service API may include determining whether information about a service API should be provided to an API Invoker and/or whether the API is able to provide the functionality that is requested (e.g., required) by the API Invoker.

CAPIF capabilities may enable use cases and/or deployments where service APIs may be discovered, and where the discovery operation may consider that API providers may have different datasets.

The terms “dataset” or “server dataset” or “service API dataset” or “API provider dataset” can be used interchangeably and may refer to a collection of data stored and managed on a server, designed to support applications, services, or analytical tasks.

A dataset may be hosted in a centralized manner or in a distributed manner and accessed through network protocols, for example, such as HTTP, FTP, or database-specific protocols via an API.

A distributed dataset may be synchronized or unrelated. In a synchronized dataset, a (e.g., each) distributed host may have the same dataset. In an unrelated dataset, a (e.g., each) distributed host may independently have a different dataset.

Examples of a dataset may include information stored in a database, information stored in files, information obtained via a stream (e.g., sensor information), pre-trained ML models, and AI data used to perform inference.

CAPIF API discovery may be performed, for example, based on a distributed dataset.

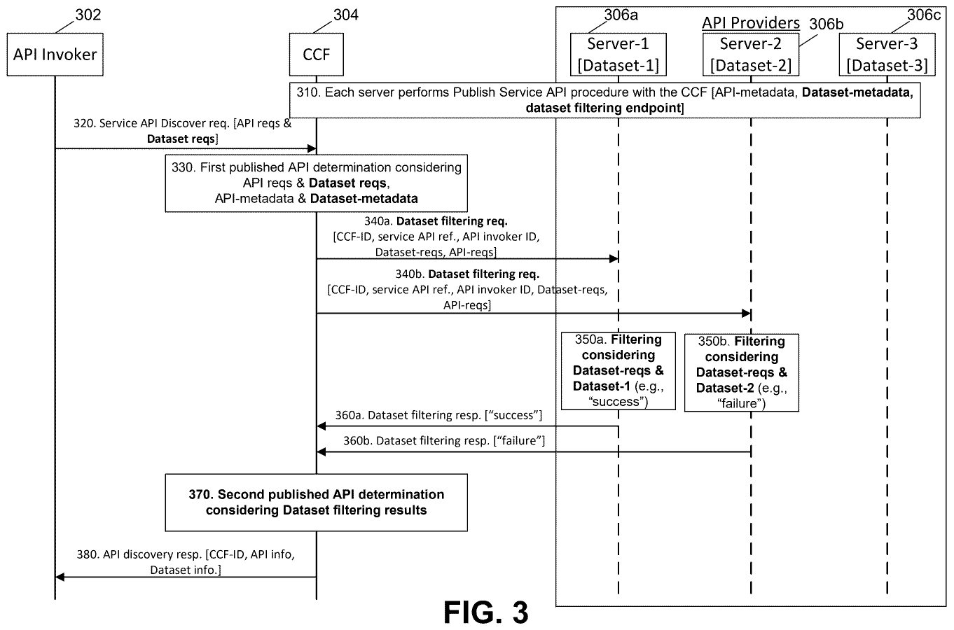

FIG. 3 shows an example CAPIF API discovery based on a distributed dataset.

As shown in FIG. 3 at 310, API providers (e.g., Server-1 306a, Server-2 306b, Server-3 306c) may perform a Publish Service API procedure with the CCF 304 (e.g., send a message to the CCF 304). The Service API publish request may include the API publisher identity information and the Service API information. For example, the request may include dataset-metadata and a dataset filtering endpoint associated with the published service API. For example, the CCF may receive one or more of the following: a first message from a first API provider (e.g., Server-1) indicating first dataset metadata and a first dataset filtering endpoint; a second message from a second API provider (e.g., Server-2) indicating second dataset metadata and a second dataset filtering endpoint; and/or a third message from a third API provider (e.g., Server-3) indicating a third dataset metadata and a third dataset filtering endpoint.

The dataset metadata may include information about the dataset available at the API provider (e.g., server). For example, the dataset metadata may include information about a location (e.g., latitude, longitude, altitude, civic address, room identifier, etc.) applicable to the dataset of the API provider. The dataset metadata may include information about a time period (e.g., past month, past year, etc.) applicable to the dataset. The dataset metadata may include information about the dataset category (e.g., sensor information, AIML models, spatial maps, etc.). The dataset metadata may indicate the identity of data sources that are accessible to the API provider. For example, the dataset metadata may identify networks (e.g., visited public land mobile network identifiers (VPLMN IDs)), network slices (e.g., single network slice selection assistance information (S-NSSAIs)), or Network Functions (NF IDs) that the API provider may obtain data from when an API is invoked.

The dataset filtering endpoint information may indicate an API endpoint available at the service API that may be used by the CCF to perform queries about the server dataset. The CCF may invoke the dataset filtering endpoint of an API provider (e.g., to determine if the API invoker requirements can be fulfilled), for example, if the CCF cannot determine a service API to fulfill the API invoker dataset requirements (e.g., first API determination as described at 330 in FIG. 2). The CCF may send a request to the Server (e.g., API provider). The request may indicate dataset parameters (e.g., requirements) of the API Invoker. The request may be addressed to the dataset filtering endpoint. The CCF may receive a response from the Server. The response may indicate whether or not the dataset meets the parameters (e.g., requirements) of the API Invoker.

As shown in FIG. 3 at 320, the API invoker 302 (e.g., an application that runs on a WTRU) may send a Service API Discovery request to the CCF. The request may include the API invoker identity information and query information about the Service API (e.g., API requirements). The request may include dataset one or more parameters or requirements.

The dataset parameter (e.g., requirement(s)) may include information related to the dataset that may be used (e.g., requested (e.g., required)) by the API invoker. For example, the API invoker may indicate that a dataset is used (e.g., required) for a location (e.g., certain location), a time period (e.g., certain time period), or a dataset category (e.g., certain dataset category). A dataset being used (e.g., required) by the API Invoker may mean that the API Invoker is to use (e.g., request (e.g., require)) data that is related to a dataset to be provided to the API Invoker. A dataset being used (e.g., required) by the API Invoker may mean that the API Invoker requests (e.g., requires) that a Server (e.g., that executes the API to be used (e.g., needed) by the API Invoker), may have access to data that is related to a dataset in order to execute the task(s) that are requested by the API invocation. The dataset parameter (e.g., requirement(s)) may indicate the identity of data sources that may be (e.g., need to be) accessible to the API provider. For example, the dataset requirements may identify networks (e.g., VPLMN IDs), network slices (e.g., S-NSSAIs), or Network Functions (NF IDs) that the API provider may obtain data from (e.g., need to obtain data from) when an API is invoked.

The API invoker may include (e.g., in the Service API Discovery request) an indication that the dataset parameter (e.g., requirement(s)) is private, for example, if the dataset requirement(s) contain sensitive information that may not be interpreted by the CCF. If the dataset parameters (e.g., requirements) are private, an opaque container may be used by the CCF to pass the private dataset parameters (e.g., requirements) to the applicable API providers. For example, the dataset parameter (e.g., requirement) may be included in the dataset filtering request without being evaluated.

As shown in FIG. 3 at 330, the CCF may make a first determination of published service APIs that may fulfill the parameters (e.g., requirements) provided in the Service API Discovery request. The first determination may be based on the published service API information (e.g., API publisher identity information, Service API information) and the dataset metadata provided to the CCF (e.g., as shown at 310), and may be based on the API parameters (e.g., requirements) and dataset parameters (e.g., requirements) provided to the CCF (e.g., as shown at 320).

For example, the CCF may perform a first comparison based on comparing the Service API information of published service APIs with the API parameters (e.g., requirements) received in the discovery request to determine a first subset of published APIs that may fulfill the API invoker parameters (e.g., requirements).

For example, the CCF may perform a second comparison based on comparing the dataset parameters (e.g., requirements) received in the discovery request with the dataset metadata of published service APIs of the determined first subset of published service APIs to further determine a second subset of service APIs that may fulfill the API invoker parameters (e.g., requirements). If the dataset parameters (e.g., requirements) are private, then the second comparison may be refrained from being performed (e.g., cannot be made), and the second subset may be equivalent to the first subset of published APIs.

For example, the CCF may determine if the service APIs included in the second subset of published service APIs fulfill one or more parameters (e.g., all requirements) included in the Service API Discovery request. If the CCF determines that the second subset of published service APIs fulfills the API invoker parameters, the CCF may proceed to 380 in FIG. 3 to inform the API invoker of determined published service APIs. If the CCF does not determine that the second subset of published service APIs fulfills the API invoker parameters, the CCF may proceed to 340a and/or 340b in FIG. 3.

As shown in FIG. 3 at 340, the CCF may send a Dataset Filtering request to one or more API providers (e.g., determined in 330). The API providers (e.g., determined in 330) may be the API providers that published the determined service APIs. The determined service APIs may be the service APIs included in the second subset of services APIs, included in the first subset of service APIs, or any published service APIs. The CCF may send the request towards the dataset filtering endpoint provided by the API provider in 310. The request may include information about the CCF (e.g., CCF identifier), the published service API reference (e.g., Service API published information reference), the API invoker identity information (e.g., API invoker identifier), the dataset parameters (e.g., requirements) provided by the API invoker, and/or query information about the Service API (e.g., API requirements).

If the dataset parameters (e.g., requirements) are private, the opaque container may be forwarded to the API providers (e.g., the private dataset requirements may be included in the dataset filtering request, for example, without being evaluated by the CCF). For example, the API provider may interpret the dataset requirements and may determine whether the API provider and dataset fulfill the dataset requirements.

The CCF identifier and published service API reference may be used by the API provider to identify the specific API for which the request is sent. For example, an API may be associated with a specific dataset at the API provider, and identifying the API may be necessary to identify the dataset. For example, an API provider may publish several APIs, and identifying the published API may be performed (e.g., necessary).

The API invoker identity may be used by the API provider to determine the dataset to be considered. For example, an API invoker may have access to a limited dataset. The API provider may use the API invoker identity (e.g., need to know the API invoker identity) to determine the dataset that may be considered for the request.

In an example, the dataset requirements and API requirements may be used by the API provider to identify the dataset that may be considered for the request. For example, the API requirements may indicate a limited dataset for consideration. For example, the dataset requirements may be used by the API provider to determine if the dataset to be considered can fulfill the dataset requirement.

For example, the API provider may be a spatial map server. The dataset parameter (e.g., requirement) may include an area of interest. The API provider may determine if the dataset to be considered for the requestor is sufficient to generate a spatial map for the area of interest provided by the requestor.

The CCF may send the Dataset Filtering request at 304a and/or at 340b (e.g., sequentially) to one or more API providers (e.g., determined in 330). The CCF may send one or more Dataset Filtering requests at 304a and/or 340b (e.g., concurrently) to one or more API providers (e.g., determined in step 330).

For example, FIG. 3 shows that example three API providers (e.g., Server-1, Server-2, Server-3) may have published service APIs with the CCF (e.g., in 310), that the CCF first determination (e.g., in 330) may have resulted in a subset of two API providers (e.g., Server-1, Server-2), and that the CCF may send concurrently a Dataset Filtering request (e.g., as shown at 340a and 340b in FIG. 3) to the determined API providers (e.g., Server-1, Server-2) to determine which API provider can fulfill the API invoker parameters (e.g., requirements).

As shown in FIG. 3 at 350a and 350b, the API provider may determine (e.g., as shown at 350a and 350b) if the dataset parameters (e.g., requirements) provided in the request can be fulfilled. The API provider may perform one or more of the following actions: identify a published service API and/or a dataset associated with the identified published service API using the CCF identifier and published service API reference, identify a dataset based on the API invoker identifier, and/or identify a dataset based on the API parameters (e.g., requirements) received in the request. The API provider may determine a capability of the API provider and determined dataset to fulfill the dataset parameter (e.g., requirement) provided in the request, for example, based on the identified dataset.

As shown in FIG. 3 at 360a and 360b, the API provider may send a Dataset filtering response (e.g., 360a and 360b) to the CCF. The response may include an indication of the determined capability of the API provider and dataset (e.g., in 350a and/or 350b). The response may indicate a successful fulfillment capability, a failed fulfillment capability, or a partial fulfillment capability.

The response may indicate (e.g., in case of failed fulfillment capability) the reason for the failure. For example, the API provider may indicate that the API invoker may not be authorized to access the fulfilled dataset.

As shown in FIG. 3 at 370, the CCF may make a second determination of published service APIs that may fulfill the parameters (e.g., requirements) provided in the Service API Discovery request. The second determination may be performed based on the Dataset Filtering responses from the one or more API providers. The second determination may result in one or more published service APIs that are capable of fulfilling (e.g., fully or partially) the API invoker parameters (e.g., requirements), or may result in no published service API that may fulfill the API invoker parameters (e.g., requirements).

As shown in FIG. 3 at 380, the CCF may send a Service API discovery response to the API invoker. The response may indicate if the Service API discovery processing was successful and may include the CCF identifier and the determined published service APIs. The response may indicate whether the parameter (e.g., requirement) fulfillment is complete or partial for a (e.g., each) determined published service API included in the response. For example, the response may indicate that the dataset associated with a published service API completely fulfills dataset requirements. For example, the response may indicate that the dataset associated with a published service API partially fulfills dataset requirements. The API invoker may select a published service API based on the level of fulfillment indicated in the response.

In case the CCF determines that the API invoker request may not be fulfilled, the CCF may send (e.g., together with the failure indication) a reason for the failure of fulfillment.

For example, the CCF may indicate that no API provider can fulfill the API invoker request. The CCF may indicate that no API provider is able to fulfill this request, for example, due to an authorization issue (e.g., some API providers may have the dataset that meets the API invoker parameters (e.g., requirements), but the API invoker doesn't have the full authorization to access or use this dataset through this API provider).

Including the determined published service APIs in the response may result in the response including information about discovered service APIs, for example, which may include a service API name, an API provider name, an API category, an API communication type, an API description, an API serving area, API interface details (e.g., endpoint, URL, URI, IP address, port number), API protocols, an API version that may be used to communicate with the discovered API, an indication of fulfillment of dataset parameter(s) (e.g., requirement(s)), and/or an indication of the level of fulfilment (e.g., fully or partially) of the dataset parameter (e.g., requirement).

The API invoker may send messages to a discovered service API, for example, to obtain a service from an API provider. The API invoker may send a message to the service API of the API provider to obtain information, and the obtained information may be based on the dataset available at the API provider, which is associated with (e.g., request) discovering a service API associated with an appropriate dataset.

The Retrieve Service API procedure may support distributed datasets. The Service API get request may include dataset parameters (e.g., requirements, as described in FIG. 3 at 320) such that the CCF may perform 340 through 370 of FIG. 3, for example, to determine the requested service API.

The Update Service API procedure may support distributed datasets. The Service API update request may include dataset metadata and dataset filtering endpoints, for example, to allow an API provider to perform management of published service APIs. For example, the API provider may perform the Update Service API procedure to indicate a change in the dataset-metadata.

The CAPIF events Subscription procedure may support distributed datasets. The Event subscription request may include dataset parameters or requirements (e.g., as described in FIG. 3 at 320), for example, such that the CCF may detect when published service APIs (e.g., newly published or updated) can fulfill the dataset parameters or requirements provided in the subscription. When the CCF detects a published service API change (e.g., newly published or updated), the CCF may perform 330 to 370 of FIG. 3, for example, to determine if the changed published service API can fulfill the dataset parameters provided in the subscription, and the CCF may accordingly trigger a notification (e.g., a Service API updated event or a dataset change event).

The CAPIF events notification procedure may support distributed datasets. The list of CAPIF events may include a dataset change event, for example, which may indicate that the dataset associated with a published service API and/or API provider may have changed and/or may fulfill the dataset-requirements provided in the corresponding subscription. For example, the API provider may perform the Update Service API procedure with the CCF, the CCF may detect the publish service API change and perform 330 to 370 of FIG. 3 to determine if the changed published service API may fulfill the dataset-requirements provided in the subscription, and the CCF may send an event notification (e.g., Service API updated event or a dataset change event) to the API invoker indicating a partial or complete dataset match.

The CCF may (e.g., at 360 in FIG. 3) store the capability information included in the response in storage (e.g., a cache storage) local to the CCF along with the Service API Discovery request parameters such that 340a, 340b, 350a, 350b, 360a, and 360b may be avoided for future requests with the same parameters. The response may include a validity time period for caching the result, and the validity time may indicate that the result may not be cached, may be cached for a period of time, or that there is no expiration for caching the result. An API provider may perform the Update Service API procedure. The Update Service API procedure may indicate a dataset change, which may instruct the CCF to remove related cache entries.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed is

1. A first network entity, comprising
a processor configured to:
receive, from a first application programming interface (API) provider, a first message indicating a first dataset metadata associated with the first API provider, and indicating a first dataset filtering endpoint associated with the first API provider;
receive, from a second API provider, a second message indicating a second dataset metadata associated with the second API provider, and indicating a second dataset filtering endpoint associated with the second API provider;
receive a service API discovery request indicating a dataset requirement;
determine that the first API provider or the second API provider fails to satisfy a condition based on the first dataset metadata, the second dataset metadata, and the dataset requirement;
send a dataset filtering request to at least one of the first dataset filtering endpoint and the second dataset filtering endpoint, wherein the dataset filtering request indicates the dataset requirement;
receive a dataset filtering response;
select at least one of the first API provider or the second API provider based on the dataset filtering response; and
send a service API discovery response based on the selected at least one of the first API provider or the second API provider.

2. The first network entity of claim 1, wherein the service API discovery request is received from at least one of a wireless transmit/receive unit (WTRU) or a second network entity.

3. The first network entity of claim 1, wherein the dataset filtering request is a first dataset filtering request, and wherein the processor is further configured to:
determine to send the first dataset filtering request to the first API provider based on the first dataset metadata and the dataset requirement; and
determine to send a second dataset filtering request to the second API provider based on the second dataset metadata and the dataset requirement.

4. The first network entity of claim 1, wherein the dataset filtering response indicates a capability and a dataset.

5. The first network entity of claim 1, wherein the first network entity is a common API framework core function (CCF) network entity.

6. The first network entity of claim 1, wherein the first dataset metadata indicates one or more of first location information, first time information, a first dataset category, a first set of data sources, a first set of networks, a first set of network slices, or a first set of network functions, and wherein the second dataset metadata indicates one or more of second location information, second time information, a second dataset category, a second set of data sources, a second set of networks, a second set of network slices, or a second set of network functions.

7. The first network entity of claim 1, wherein the dataset requirement indicates one or more of a network, a network slice, or a network function.

8. The first network entity of claim 1, wherein the service API discovery request indicates that the dataset requirement is associated with sensitive information, wherein based on a determination that the dataset requirement is associated with sensitive information, the dataset requirement is included in the dataset filtering request without being evaluated.

9. A method performed by a first network entity, comprising
receiving, from a first application programming interface (API) provider, a first message indicating a first dataset metadata associated with the first API provider, and indicating a first dataset filtering endpoint associated with the first API provider;
receiving, from a second API provider, a second message indicating a second dataset metadata associated with the second API provider, and indicating a second dataset filtering endpoint associated with the second API provider;
receiving a service API discovery request indicating a dataset requirement;
determining that the first API provider or the second API provider fails to satisfy a condition based on the first dataset metadata, the second dataset metadata, and the dataset requirement;
sending a dataset filtering request to at least one of the first dataset filtering endpoint and the second dataset filtering endpoint, wherein the dataset filtering request indicates the dataset requirement;
receiving a dataset filtering response;
selecting at least one of the first API provider or the second API provider based on the dataset filtering response; and
sending a service API discovery response based on the selected at least one of the first API provider or the second API provider.

10. The method of claim 9, wherein the service API discovery request is received from at least one of a wireless transmit/receive unit (WTRU) or a second network entity.

11. The method of claim 9, wherein the dataset filtering request is a first dataset filtering request, and wherein the method further comprises:
determining to send the first dataset filtering request to the first API provider based on the first dataset metadata and the dataset requirement; and
determining to send a second dataset filtering request to the second API provider based on the second dataset metadata and the dataset requirement.

12. The method of claim 9, wherein the dataset filtering response indicates a capability and a dataset.

13. The method of claim 9, wherein the first network entity is a common API framework core function (CCF) network entity.

14. The method of claim 9, wherein the first dataset metadata indicates one or more of first location information, first time information, a first dataset category, a first set of data sources, a first set of networks, a first set of network slices, or a first set of network functions, and wherein the second dataset metadata indicates one or more of second location information, second time information, a second dataset category, a second set of data sources, a second set of networks, a second set of network slices, or a second set of network functions.

15. The method of claim 9, wherein the dataset requirement indicates one or more of a network, a network slice, or a network function.

16. The method of claim 9, wherein the service API discovery request indicates that the dataset requirement is associated with sensitive information, wherein based on a determination that the dataset requirement is associated with sensitive information, the dataset requirement is included in the dataset filtering request without being evaluated.
